(19) United States
(12) Patent Application Publication
(10) Pub. No.: US 2020/0122298 A1
(43) Pub. Date: Apr. 23, 2020

(54) NONWOVEN ANTIMICROBIAL SCRUB PAD

(71) Applicants: SAINT-GOBAIN ABRASIVES, INC., Worcester, MA (US); SAINT-GOBAIN ABRASIFS, Conflans-Sainte-Honorine (FR)

(72) Inventors: Kushal SINGLA, Sangrur (IN); Ramesh Muthusamy, Chennai (IN); Rishwanth SATHYAMURTHY, Bangalore (IN)

(21) Appl. No.: 16/622,133

(22) PCT Filed: Jun. 15, 2018
(86) PCT No.: PCT/US2018/037862

§ 371 Date: Dec. 12, 2019

(30) Foreign Application Priority Data
Jun. 21, 2017 (IN) 201741021708

(51) Int. Cl. B24D 3/34; B24D 3/00; A01N 25/34; A01N 43/16; A01N 35/08; A01N 43/68; A01N 31/08

(52) U.S. Cl. CPC B24D 3/348; B24D 3/005; A01N 25/34; A01N 31/08; A01N 35/08; A01N 43/68; A01N 43/16

(57) ABSTRACT

An antimicrobial abrasive article comprising a nonwoven substrate material impregnated with a first and second formulation. The first and second formulations have persistent residual antimicrobial effectiveness against one or more microbial organisms. The first and second formulations include one or more antimicrobial agents and abrasive particles uniformly dispersed in a polymer composition. The first and second antimicrobial agents can be the same or different. The polymer compositions can be the same or different.

### FIELD OF THE DISCLOSURE

The present invention relates generally to antimicrobial nonwoven abrasive articles and, more particularly, to antimicrobial nonwoven abrasive articles that possess persistent residual antimicrobial efficacy.

Nonwoven abrasive articles used for cleaning, such as nonwoven abrasive scrub pads, can harbor microorganisms such as bacteria and fungi that can thrive and rapidly multiply in moist environments. Consequently, it is desirable to use materials that are effective at cleaning and that control or prevent the growth of unwanted microorganisms on nonwoven abrasive articles. Although various approaches have been taken to try to solve the problem of microbial growth on nonwoven abrasive articles used for cleaning, such approaches have not produced nonwoven abrasive articles that have long lasting effects on wide variety of organisms. Therefore, there continues to be a demand for improved antimicrobial nonwoven abrasive articles.

### BRIEF DESCRIPTION OF THE DRAWINGS

The present disclosure can be better understood, and its numerous features and advantages made apparent to those skilled in the art by referencing the accompanying drawings.

FIG. 1 includes an illustration of a perspective view of an antimicrobial nonwoven abrasive article according to an embodiment.

FIG. 2 includes an illustration of a surface view of the callout portion of the embodiment of FIG. 1.

FIG. 3 includes an illustration of an interior view of the callout portion of the embodiment of FIG. 1.

FIG. 4 includes a flow diagram including a method of making an antimicrobial nonwoven abrasive article according to an embodiment.

FIG. 5 includes a top view illustration of a zone of inhibition result of an antimicrobial nonwoven abrasive article according to an embodiment.

FIG. 6 includes an array of images of the results of zone of inhibition testing against Escherichia coli (“E. coli”) and Klebsiella pneumonia (“K. pneumonia”) for new (“fresh”), unused antimicrobial nonwoven abrasive articles; specifically control samples, comparative samples, and inventive samples according to an embodiment.

FIG. 7 includes an array of images of the results of zone of inhibition testing against Escherichia coli (“E. coli”) and Klebsiella pneumonia (“K. pneumonia”) for used inventive sample antimicrobial nonwoven abrasive articles according to an embodiment.

The use of the same reference symbols in different drawings indicates similar or identical items.

### DETAILED DESCRIPTION OF THE PREFERRED EMBODIMENT(S)

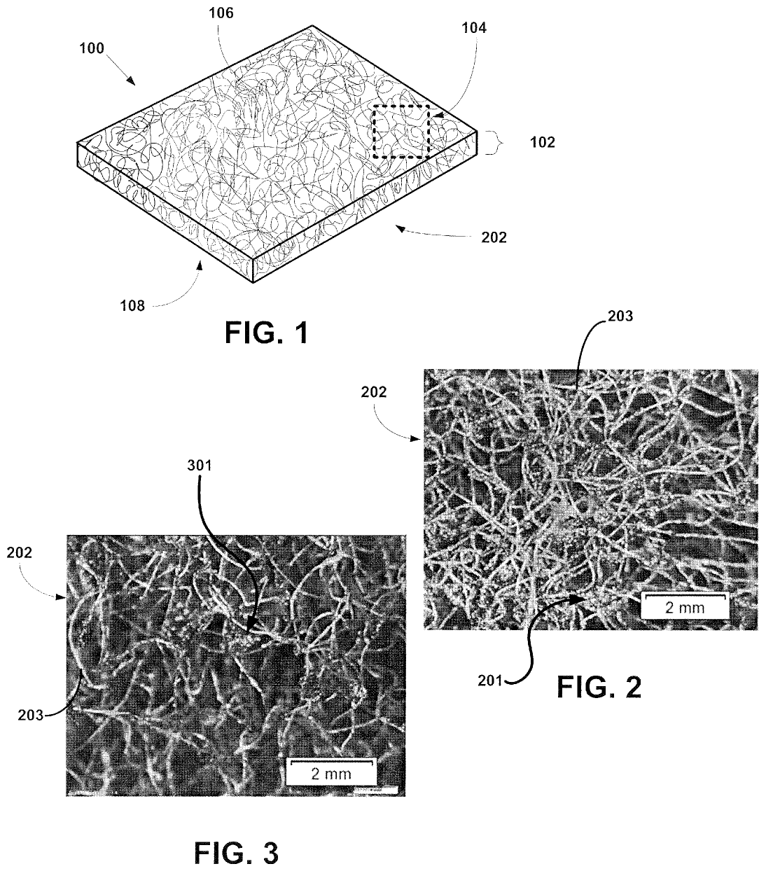

FIG. 1 includes an illustration of a perspective view of an antimicrobial nonwoven abrasive article 100 according to an embodiment. In particular, antimicrobial nonwoven abrasive article 100 can include a nonwoven substrate, and more particularly can be configured as a scrubber pad useful for cleaning in a moist environment, such as in a kitchen, bathroom, lavatory, hand washing station, floor, or tile. In an embodiment, an antimicrobial nonwoven abrasive article can have a body having any regular or irregular shape. In an embodiment, an antimicrobial nonwoven abrasive article can have two major sides opposite each other and generally parallel to each other. In the embodiment illustrated in FIG. 1, the antimicrobial nonwoven abrasive article 100 can have a generally square or rectangular shape, a first surface 106, a second surface 108 generally opposite of the first surface 106, and a thickness 102 extending from the first surface 106 to the second surface 108. According to an embodiment, the antimicrobial nonwoven abrasive article 100 can have one or more antimicrobial formulations coated, dipped, sprayed, adhered to, or otherwise disposed on one or more of the first surface 106 or the second surface 108, and additionally within and throughout the thickness 102. In particular, the one or more antimicrobial formulations can include an antimicrobial agent.

FIG. 2 includes an illustration of a surface view of a callout portion 104 of the antimicrobial nonwoven abrasive article 100 of FIG. 1. The antimicrobial nonwoven abrasive article 100 can include an antimicrobial formulation having one or more antimicrobial agents disposed on the surface of the antimicrobial nonwoven abrasive article 100. As illustrated, a antimicrobial formulation 201 including an antimicrobial agent can be coated on portions of an interlocked web 202 formed of nonwoven filaments 203.

FIG. 3 includes an illustration of an interior view of the callout portion 104 of the antimicrobial nonwoven abrasive article 100 of FIG. 1. The antimicrobial nonwoven abrasive article 100 can include an antimicrobial formulation having one or more antimicrobial agents disposed within and throughout the thickness 102 of the antimicrobial nonwoven abrasive article 100, as represented by FIG. 3. As illustrated, a antimicrobial formulation 301 including one or more antimicrobial agents can be coated on portions of an interlocked web 202 formed of nonwoven filaments 203. In an embodiment, the antimicrobial formulation 301 disposed within and throughout the thickness 102 can be the same or different from the antimicrobial formulation 201 disposed on the one or more surfaces 106, 108 of the antimicrobial nonwoven abrasive article 100.

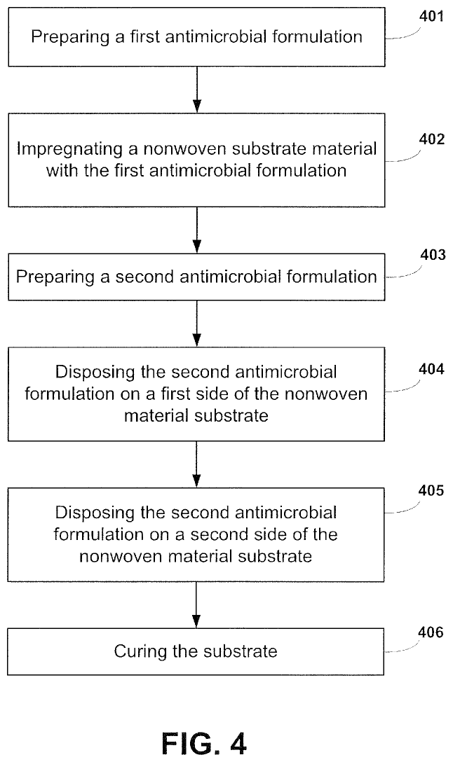

FIG. 4 includes an illustration of a flow diagram for a method of making an abrasive article having an antimicrobial agent in accordance with an embodiment. Step 401 of FIG. 4 includes preparing a first antimicrobial formulation. In a particular embodiment, a dip coating antimicrobial formulation can be prepared in step 401. In step 402, impregnating the nonwoven substrate material with the first antimicrobial formulation occurs. In a particular embodiment, the impregnation is accomplished by dipping the nonwoven substrate material in the first antimicrobial formulation and squeezing out excess antimicrobial formulation. Step 403, includes preparing a second antimicrobial formulation. In a particular embodiment, a spray antimicrobial formulation can be prepared in step 403. Step 404 includes disposing the second antimicrobial formulation on a first side of the nonwoven substrate material. In a particular embodiment, disposing the second antimicrobial formulation is accomplished by spraying the second antimicrobial formulation. Step 405 includes disposing the second antimicrobial formulation on a second side of the nonwoven substrate material. In a particular embodiment, disposing the second antimicrobial formulation is accomplished by spraying the second antimicrobial formulation. Step 406 includes curing the substrate to form an abrasive article. In a particular embodiment, the curing can be accomplished by heating the saturated nonwoven material substrate in an oven so as to cure the first antimicrobial formulation and the second antimicrobial formulation.

### First Antimicrobial Formulation

In an embodiment, a nonwoven substrate material is impregnated with a first antimicrobial formulation, wherein the first antimicrobial formulation has persistent residual antimicrobial effectiveness against one or more microbial organisms; and wherein the first antimicrobial formulation comprises a first antimicrobial agent and abrasive particles uniformly dispersed in a first polymer composition. In a particular embodiment, the first antimicrobial formulation has persistent residual antimicrobial effectiveness against Staphylococcus aureus (also referred to herein as “S. aureus”), and one or more of Klebsiella pneumonia (also referred to herein as “K. pneumonia”), and Escherichia coli (also referred to herein as “E. coli”).

In accordance with an embodiment, the first antimicrobial formulation comprises a first antimicrobial agent. In a particular embodiment, a first antimicrobial formulation can be configured as a coating that impregnates the nonwoven substrate material and adheres to the fibers of the nonwoven substrate material throughout the thickness of the non-woven material.

As described further herein, the first antimicrobial formulation can be applied in any suitable manner that impregnates the nonwoven substrate material in a selective or uniform manner throughout the nonwoven material. FIG. 2 and FIG. 3 illustrate a first antimicrobial formulation disposed on (i.e., adhered to) the fibers of the surface and the interior of a nonwoven material substrate according to an embodiment.

In accordance with an embodiment, the first antimicrobial formulation comprises a first antimicrobial agent. The first antimicrobial agent can comprise a compound that has antimicrobial properties as understood by those of ordinary skill in the art, such as the ability to kill (e.g., bactericidal) or inhibit the growth (e.g., bacteriostatic) of microscopic organisms such as, for example, bacteria, fungi, or protozoa. Examples of first antimicrobial agents can include bronopol (2-Bromo-2-nitropropane-1,3-diol), chitosan (a hydrophilic polysaccharide derived from chitin), tannic acid, mixtures thereof, blends thereof, or any combination thereof. A first antimicrobial agent can be available in one or more formats, such as a solution, a suspension, an emulsion, a sol, a gel, a solid, a powder, a composite material, or combinations thereof. A first antimicrobial agent can be in a suitable particle size, more particularly micron sized particles, nano sized particles, or a combination thereof. In a particular embodiment, a first antimicrobial agent can be in combination with a polymer, a polymer composite, or combinations thereof. In a particular embodiment, the first antimicrobial agent can include a brominated diol and more particularly, 2-Bromo-2-nitropropane-1,3-diol(commonly known as “Bronopol”). In a particular embodiment, the first antimicrobial agent can comprise chitin, a deacetylated form of chitin, or combinations thereof. In a particular embodiment, the deacetylated form of chitin can comprise a linear polysaccharide composed of randomly distributed β-linked D-glucosamine and N-acetyl-D-glucosamine. In a particular embodiment the deacetylated form of chitin comprises chitosan, a co-polymer of (1→4)-2-amine-2-deoxy-β-D-glucan and (1→4)-2-acetamide-2-deoxy-β-D-glucan, or derivatives thereof. In a specific embodiment, the chitosan can comprise a solution, a suspension, an emulsion, a sol, a gel, a solid, a powder, a composite material, or combinations thereof. In a particular embodiment, the chitosan can be in combination with a polymer, a polymer composite, or combinations thereof. In a particular embodiment, a first antimicrobial agent can comprise a tannin, a tannic acid, mixtures thereof, blends thereof, or any combination thereof. In a particular embodiment, a first antimicrobial agent can comprise a tannic acid In a particular embodiment the tannic acid can comprise acidum tannicum, gallotannic acid, digallic acid, gallotannin, tannimum, quercitannin, oak bark tannin, quercotannic acid, quercitannic acid, mixtures thereof, blends thereof, or any combination thereof. In a specific embodiment, the tannic acid can comprise a solution, a suspension, an emulsion, a sol, a gel, a solid, a powder, a composite material, or combinations thereof. In a particular embodiment, the tannic acid can be in combination with a polymer, a polymer composite, or combinations thereof. In a particular embodiment, the first antimicrobial agent can comprise bronopol, tannic acid, chitosan, mixtures thereof, blends thereof, or any combination thereof. In a particular embodiment, the first antimicrobial agent can consist essentially of bronopol, tannic acid, chitosan, mixtures thereof, blends thereof, or any combination thereof. As used herein, the phrase “consist essentially of,” “consisting essentially of,” “consists essentially of,” or any such an equivalent phrase, limits the scope of the antimicrobial agent to the specified antimicrobial agent, but the scope can include other materials that do not materially affect the characteristic of being an antimicrobial agent as defined herein. In other words, an abrasive article according to an embodiment that consists essentially of bronopol, tannic acid, chitosan, mixtures thereof, blends thereof, or any combination thereof does not include another antimicrobial agent.

In an embodiment, the first antimicrobial formulation can provide the nonwoven abrasive article a persistent residual antimicrobial effectiveness against one or more microbial organisms. Persistent residual antimicrobial effectiveness can be defined as capable of killing at least 85%, such as at least 90, or at least 95% of the population of an initial inoculation of one or more microbial organisms after 1 hr., and further defined as killing at least 90% after seven days. Such persistent residual antimicrobial effectiveness can occur when the antimicrobial nonwoven article is a virgin sample (i.e., a new sample not yet subjected to washing utensils or other cleaning procedures) or a used sample (i.e., which has be subjected to washing utensils or other cleaning procedures). In an embodiment, the antimicrobial abrasive article provides persistent residual antimicrobial effectiveness even when the nonwoven abrasive article has been used and stored under wet conditions for seven days (e.g., washing 200 utensils or even up to six hundred utensils and then storing the antimicrobial nonwoven abrasive article in sealed bag before testing). Alternatively, persistent residual effectiveness against one or microbial organisms can be defined as capable of producing a zone of inhibition around a sample of the abrasive article, wherein the zone of inhibition is at least a particular specified distance around the sample, such as at least 1 cm, at least 2 cm, or at least 3 cm, for a population of one or more microbial organisms for the specified 1 hr and seven day time periods. In a specific embodiment, a first antimicrobial agent possesses persistent residual antimicrobial effectiveness when it satisfies either of the definitions of persistent residual effectiveness. In a specific embodiment, a first antimicrobial agent possesses persistent residual antimicrobial effectiveness when it satisfies both definitions of persistent residual effectiveness.

In a particular embodiment, the first antimicrobial agent can have a persistent residual antimicrobial effectiveness against S. aureus, and one or more of K. pneumoniae, and E. coli. Persistent residual antimicrobial effectiveness can be defined as capable of killing at least 85%, such as at least 90%, or at least 95% of the population of an initial inoculation of E. coli after 1 hour, at least 85%, such as at least 90%, or at least 95% of the population of an initial inoculation of K. pneumoniae after 1 hour, and killing at least 95% of the population of an initial inoculation of S. aureus after 1 hour in accordance with test method ASTM: E2149-13A. Alternatively, persistent residual antimicrobial effectiveness can be defined as capable of producing a zone of inhibition around a sample of the abrasive article, wherein the zone of inhibition is a particular specified distance around the sample, such as at least 1 cm, at least 2 cm, or at least at least 3 cm for a population of S. aureus, and one or more of K. pneumoniae, and E. coli for a 1.0 cm by 1.0 cm (1.0 cm2) abrasive article sample tested according to the Kirby-Bauer antibiotic testing method (also commonly known as KB testing or disk diffusion antibiotic sensitivity testing. In a specific embodiment, a first antimicrobial agent possesses persistent residual antimicrobial effectiveness when it satisfies either of the definitions of persistent residual effectiveness. In a specific embodiment, a first antimicrobial agent possesses persistent residual antimicrobial effectiveness when it satisfies both definitions of persistent residual effectiveness.

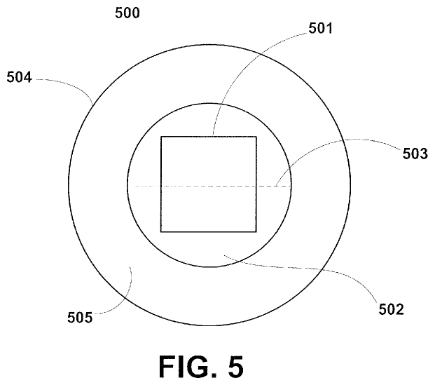

FIG. 5, illustrates a top view of a bacterial sample 505 contained within petri dish 504. Surrounding abrasive article 501 is a zone of inhibition 502 having a diameter 503 indicating effective antimicrobial properties of the abrasive article.

The first antimicrobial formulation can include a first antimicrobial agent in a particular concentration. In an embodiment, the first antimicrobial formulation can include a first antimicrobial agent at a concentration of at least 0.1 wt % of the total weight of the antimicrobial formulation, such as at a concentration of at least 0.2 wt %, at least 0.3 wt %, at least 0.4 wt %, at least 0.5 wt %, at least 0.6 wt %, at least 0.7 wt %, at least 0.8 wt %, at least 0.9 wt %, at least 1.0 wt %, at least 1.1. wt %, at least 1.2 wt %, at least 1.3 wt %, at least 1.4 wt %, or at least 1.5 wt %. In a non-limiting embodiment, the first antimicrobial formulation can include an antimicrobial agent at a concentration of not greater than 5.0 wt % of the total weight of the antimicrobial formulation, such as at a concentration of not greater than not greater than 4.5 wt %, not greater than 4.0 wt %, not greater than 3.5 wt %, not greater than 3.0 wt %, not greater than 2.5 wt %, not greater than 2.0 wt %, or not greater than 1.5 wt %. It will be appreciated that the first antimicrobial formulation can include an antimicrobial agent at a concentration within any range of maximum or minimum values noted above, such as within a range of from 0.1 wt % to 5.0 wt %, or within a range of from 0.5 wt % to 1.5 wt % of the total weight of the first antimicrobial formulation.

In an embodiment, the first antimicrobial formulation comprises the first antimicrobial agent and abrasive particles uniformly dispersed in a first polymer composition. In an embodiment, the first polymer composition can comprise phenolic resin, melamine formaldehyde resin, or combinations thereof. In a particular embodiment, the phenolic resin is a phenol formaldehyde resin, more particularly the phenolic resin can comprise a resole resin.

In an embodiment, the first antimicrobial formulation can include a first polymer composition in a particular concentration. In an embodiment, the first antimicrobial formulation can include a first polymer composition (total of all polymeric resins) at a concentration of at least 10 wt % of the total weight of the first antimicrobial formulation, such as at a concentration of at least 15 wt %, at least 20 wt %, at least 21 wt %, at least 22 wt %, at least 24 wt %, at least 26 wt %, at least 28 wt %, or at least 30 wt %. In a non-limiting embodiment, the first antimicrobial formulation can include a first polymer composition at a concentration of not greater than 60 wt %, such as not greater than 55 wt %, not greater than 50 wt %, not greater than 45 wt %, not greater than 40 wt %, not greater than 35 wt %, or not greater than 30 wt %. It will be appreciated that the first antimicrobial formulation can include a first polymer composition at a concentration within any range of maximum or minimum values noted above, such as within a range of 10 wt % to 60 wt %, 20 wt % to 60 wt %, 20 wt % to 50 wt %, or 30 wt % to 50 wt %, or 30 wt % to 40 wt % of the total weight of the first antimicrobial formulation.

In an embodiment, the first antimicrobial formulation can include a resole resin in a particular concentration. In an embodiment, the first antimicrobial formulation can include a resole resin at a concentration of at least 10 wt % of the total weight of the antimicrobial formulation, such as at a concentration of at least 15 wt %, at least 20 wt %, at least 21 wt %, 22 wt %, at least 24 wt %, or at least 26 wt %. In a non-limiting embodiment, the first antimicrobial formulation can include a resole resin at a concentration of not greater than 60 wt %, not greater than 50 wt %, not greater than 40 wt %, not greater than 35 wt %, such as not greater than 33%, or not greater than 30 wt %. It will be appreciated that the first antimicrobial formulation can include a resole resin at a concentration within any range of maximum or minimum values noted above, such as within a range of 15 wt % to 60 wt %, 20 wt % to 40 wt %, 20 wt % to 30 wt %, or 25 wt % to 35 wt % of the total weight of the first antimicrobial formulation.

In an embodiment, the first antimicrobial formulation can include a melamine formaldehyde resin (melamine resin), such as that commercially available under the trade name POLYFIX® from Benson Polymers Ltd, (Delhi, India).

In an embodiment, the first antimicrobial formulation can include a melamine formaldehyde resin in a particular concentration. In an embodiment, the first antimicrobial formulation can include a melamine resin at a concentration of at least 1.0 wt % of the total weight of the antimicrobial formulation, such as at a concentration of at least 2.0 wt %, at least 3.0 wt %, at least 5.0 wt %, at least 7 wt %, at least 8.0 wt %, at least 10 wt %, at least 15 wt %. In a non-limiting embodiment, the first antimicrobial formulation can include a melamine resin at a concentration of not greater than 20.0 wt %, not greater than 15.0 wt %, not greater than 10 wt %, not greater than 9 wt %, or not greater than 8.0 wt %. It will be appreciated that the first antimicrobial formulation can include a melamine resin at a concentration within any range of maximum or minimum values noted above, such as within a range of 1.0 wt % to 20.0 wt %, 5.0 wt % to 20.0 wt %, 5.0 wt % to 15.0 wt %, 7.0 wt % to 10.0 wt %, or within a range of 8.0 wt % to 9.0 wt % of the total weight of the first antimicrobial formulation.

A plurality of abrasive particles can be included in the first antimicrobial formulation. The term abrasive particles, as used herein also encompasses abrasive grains, abrasive agglomerates, abrasive aggregates, green-unfired abrasive aggregates, shaped abrasive particles, and combinations thereof. As described herein, the plurality of abrasive particles can be dispersed in a slurry coat of the first antimicrobial formulation. Thus, the abrasive particles can be disposed on the first antimicrobial formulation, be at least partially embedded in the first antimicrobial formulation, or a combination thereof. The abrasive particles can generally have a Mohs hardness of greater than about 3, and preferably in a range from about 3 to about 10. For particular applications, the abrasive particles can have a Mohs hardness of at least 5, 6, 7, 8, or 9.

In a specific embodiment, the abrasive particles have a Mohs hardness of 9. In another specific embodiment, the abrasive particles have a Mohs hardness of 6.5 to 7.5. Suitable abrasive particles include non-metallic, inorganic solids such as carbides, oxides, nitrides, silicates & aluminosilicates and certain carbonaceous materials. Oxides can include silicon oxide (such as quartz, cristobalite and glassy forms), cerium oxide, zirconium oxide, and various forms of aluminum oxide (including fused aluminas, sintered aluminas, seeded and non-seeded sol-gel aluminas). Carbides and nitrides can include silicon carbide, aluminum carbide, aluminum nitride, aluminum oxynitride, boron nitride (including cubic boron nitride), titanium carbide, titanium nitride, and silicon nitride. Carbonaceous materials can include diamond, which broadly includes synthetic diamond, diamond-like carbon, and related carbonaceous materials such as fullerite and aggregate diamond nanorods. Suitable abrasive particles can also include a wide range of naturally occurring mined minerals, such as garnet, cristobalite, quartz, corundum, feldspar, or the like, and combinations thereof. In particular embodiments, the abrasive particles can be diamond, silicon carbide, aluminum oxide, cerium oxide, or combinations thereof. Abrasive particles can be mixtures of two or more different abrasive particles or can be a single type of abrasive particle.

In an embodiment, the first antimicrobial formulation can include silica, emery, garnet, aluminum oxide, silicon carbide, or combinations thereof. The abrasive particles can be of any desired size or shape. In a specific example, the first antimicrobial formulation can include garnet particles having a mesh size of at least #120, or at least #220, at least #240.

In an embodiment, garnet particles can include a mesh size of not greater than #400. It will be appreciated that garnet particles can have a mesh size within any minimum or maximum range indicated above, and in a particular embodiment, can include a combination of mesh sizes indicated above. In a more particular embodiment, the first antimicrobial formulation abrasive particles can consists essentially of #220 garnet.

In an embodiment, the first antimicrobial formulation can include abrasive particles in a particular concentration. In an embodiment, the first antimicrobial formulation can include abrasive particles at a concentration of at least 20.0 wt % of the total weight of the first antimicrobial formulation, such as at a concentration of at least at least 30 wt %, at least 35 wt %, at least 40 wt %, at least 50 wt %. In a non-limiting embodiment, the first antimicrobial formulation can include abrasive particles at a concentration of not greater than 70 wt %, not greater than 60 wt %, not greater than 50.0 wt %, not greater than 45.0 wt %, or not greater than 40 wt %. It will be appreciated that the first antimicrobial formulation can include abrasive particles at a concentration within any range of maximum or minimum values noted above. In a particular embodiment, the first antimicrobial formulation can include abrasive particles at a concentration within a range of 30.0 wt % to 40.0 wt % of the total weight of the first antimicrobial formulation.

The first antimicrobial formulation can include one or more fillers. The filler can be a single type of filler or a mixture of fillers. The filler can serve to increase the Young's modulus of the first antimicrobial formulation. The filler can serve to modify the pH of the first antimicrobial formulation. Suitable fillers can be synthetic materials or naturally occurring materials. A filler can be an inorganic or organic material. In a particular embodiment, the first antimicrobial formulation can include a filler, such as calcium carbonate.

In an embodiment, the first antimicrobial formulation can include a filler in a particular concentration. In an embodiment, the first antimicrobial formulation can include a filler at a concentration of at least 5.0 wt % of the total weight of the first antimicrobial formulation, such as at a concentration of at least 7.0 wt %, at least 9.0 wt %, at least 10.0 wt %, at least 11 wt %. In a non-limiting embodiment, the first antimicrobial formulation can include a filler at a concentration of not greater than 30 wt %, not greater than 25 wt %, not greater than 20 wt %, not greater than 15.0 wt %, or not greater than 12 wt % of the total weight of the first antimicrobial formulation. It will be appreciated that the first antimicrobial formulation can include a filler at a concentration within any range of maximum or minimum values noted above, such as within a range of 5 wt % to 25 wt %, 7 wt % to 20 wt %, 10 wt % to 15 wt % of the total weight of the first antimicrobial formulation.

In an embodiment, the first antimicrobial formulation, prior to curing, can include water in a particular concentration. In an embodiment, the first antimicrobial formulation can include water at a concentration of at least 2.0 wt % of the total weight of the first antimicrobial formulation, such as at a concentration of at least 4.0 wt %, at least 8.0 wt %, at least 10.0 wt %, at least 12.0 wt %, or at least 13 wt %. In a non-limiting embodiment, the first antimicrobial formulation can include water at a concentration of not greater than 25 wt %, not greater than 20.0 wt %, not greater than 18.0 wt %, not greater than 16.0 wt %, or not greater than 15.0 wt %. It will be appreciated that the first antimicrobial formulation can include water at a concentration within any range of maximum or minimum values noted above, such as within a range of 10.0 wt % to 20.0 wt %.

As will be appreciated, water can be added to the first antimicrobial formulation to adjust viscosity or for varying concentrations of materials of the first antimicrobial formulation such as, in an embodiment, changes in the concentration of the antimicrobial agent.

The first antimicrobial formulation can also comprise other additives that aid the manufacture of the abrasive article. Other additives can include clays; such as kaolin; salts, pH modifiers, adhesion promoters, thickeners, plasticizers, lubricants, wetting agents, antistatic agents, pigments, dyes, coupling agents; flame retardants, degassing agents, anti-dusting agents, thixotropic agents, rheology modifiers, initiators, surfactants, chain transfer agents, stabilizers, dispersants, reaction mediators, dyes, colorants, and defoamers.

In an embodiment, a first antimicrobial formulation can comprise one or more rheology modifiers. A rheology modifier can be used to influence the viscosity of the polymer binder composition and thus influence the distribution of the abrasive particles on the surface of, or throughout the body of, the nonwoven material substrate. In an embodiment, a rheology modifier can be a single type of rheology modifier or a mixture of rheology modifiers. In an embodiment, the first antimicrobial formulation can include a wetting agent.

In an embodiment, the wetting agent can be in a particular concentration. In an embodiment, the first antimicrobial formulation can include a wetting agent in a concentration of at least 0.05 wt % of the total weight of the antimicrobial formulation. In a non-limiting embodiment, the first antimicrobial formulation can include a wetting agent in a concentration of not greater than 3.0 wt %, such as not greater than 2.0 wt %, or not greater than 1.5 wt %, of the total weight of the first antimicrobial formulation. In will be appreciated that the first antimicrobial formulation can include a wetting agent at a concentration within any range of maximum or minimum values noted above, such as with a range of 0.05 wt % to 3.0 wt % of the total weight of the first antimicrobial formulation.

In an embodiment, the first antimicrobial formulation can include a defoamer in a particular concentration. In an embodiment, the first antimicrobial formulation can include a defoamer in a concentration of at least 0.1 wt % of the total weight of the first antimicrobial formulation, such as at a concentration of at least 0.2 wt %. In a non-limiting embodiment, the first antimicrobial formulation can include a defoamer at a concentration of not greater than 3.0 wt %, such as not greater than 1.5 wt %, not greater than 1.0 wt %, or not greater than about 0.5 wt %. In will be appreciated that the first antimicrobial formulation can include a defoamer at a concentration within any range of maximum or minimum values noted above, such as with a range of 0.1 wt % to 3.0 wt % of the total weight of the first antimicrobial formulation.

In an embodiment, the first antimicrobial formulation can include a pigment. In a particular embodiment, the pigment can include a green pigment. In an embodiment, the first antimicrobial formulation can include a pigment in a particular concentration. In an embodiment, the first antimicrobial formulation can include a pigment in a concentration of at least 0.1 wt % of the total weight of the antimicrobial formulation, such as at least 0.3 wt %. In a non-limiting embodiment, the first antimicrobial formulation can include a wetting agent in a concentration of not greater than 3.0 wt %, such as not greater than 2.0 wt %, not greater than 1.0 wt %, or not greater than 0.7 wt % of the total weight of the first antimicrobial formulation. In will be appreciated that the first antimicrobial formulation can include a pigment in a concentration within any range of maximum or minimum values noted above, such as with a range of 0.1 wt % to 1.0 wt % of the total weight of the first antimicrobial formulation.

### Second Antimicrobial Formulation

In an embodiment, a nonwoven substrate material is impregnated with a second antimicrobial formulation, wherein the second antimicrobial formulation has persistent residual antimicrobial effectiveness against one or more microbial organisms; and wherein the second antimicrobial formulation comprises a second antimicrobial agent and abrasive particles uniformly dispersed in a second polymer composition. In a particular embodiment, the second antimicrobial formulation has persistent residual antimicrobial effectiveness against S. aureus, and one or more of K. pneumoniae, and E. coli. The second antimicrobial formulation can be the same as or different than the first antimicrobial formulation.

In accordance with an embodiment, the antimicrobial abrasive article can comprise a second antimicrobial formulation, alone or in combination with the first antimicrobial formulation. In a particular embodiment, the second antimicrobial formulation can be configured as a coating that is applied to and adheres to the fibers of the exterior surfaces (e.g., a first side and/or a second side) of the non-woven material. In a more particular embodiment, the second antimicrobial formulation can be configured to be a spray coating. As will be appreciated, the second antimicrobial formulation can penetrate into the body of the nonwoven substrate material, and can even saturate the nonwoven substrate material if supplied in sufficient quantities. FIG. 2 and FIG. 3 illustrate a second antimicrobial formulation disposed on (i.e., adhered to) the fibers on an exterior surface (i.e., on a side) of a nonwoven material substrate according to an embodiment.

In accordance with an embodiment, the second antimicrobial formulation can include a second antimicrobial agent. The second antimicrobial agent can be the same as or different from than the first antimicrobial agent included in the first antimicrobial formulation. The second antimicrobial agent can comprise a compound that has antimicrobial properties as understood by those of ordinary skill in the art, such as the ability to kill (e.g., bactericidal) or inhibit the growth (e.g., bacteriostatic) of microscopic organisms such as, for example, bacteria or fungi. Examples of second antimicrobial agents can include bronopol (2-Bromo-2-nitropropane-1,3-diol), chitosan (a hydrophilic polysaccharide derived from chitin), tannic acid, mixtures thereof, blends thereof, or any combination thereof. A second antimicrobial agent can be available in one or more formats, such as a solution, a suspension, an emulsion, a sol, a gel, a solid, a powder, a composite, or combinations thereof. A second antimicrobial agent can be in a suitable particle size, more particularly micron sized particles, nano sized particles, or a combination thereof. In a particular embodiment, a second antimicrobial agent can be in combination with a polymer, a polymer composite, or combinations thereof. In a particular embodiment, the second antimicrobial agent can be a brominated diol and more particularly, 2-Bromo-2-nitropropane-1,3-diol(commonly known as “Bronopol”). In a particular embodiment, the second antimicrobial agent can comprise chitin, a deacetylated form of chitin, or combinations thereof. In a particular embodiment, the deacetylated form of chitin can comprise a linear polysaccharide composed of randomly distributed β-linked D-glucosamine and N-acetyl-D-glucosamine. In a particular embodiment the deacetylated form of chitin comprises chitosan, a co-polymer of (1→4)-2-amine-2-deoxy-β-D-glucan and (1→4)-2-acetamide-2-deoxy-β-D-glucan, or derivatives thereof. In a specific embodiment, the chitosan can comprise a solution, a suspension, an emulsion, a sol, a gel, a solid, a powder, a composite material, or combinations thereof. In a particular embodiment, the chitosan can be in combination with a polymer, a polymer composite, or combinations thereof. In a particular embodiment, a second antimicrobial agent can comprise a tannin, a tannic acid, mixtures thereof, blends thereof, or any combination thereof. In a particular embodiment, a second antimicrobial agent can comprise a tannic acid In a particular embodiment the tannic acid can comprise acidum tannicum, gallotannic acid, digallic acid, gallotannin, tannimum, quercitannin, oak bark tannin, quercotannic acid, quercitannic acid, mixtures thereof, blends thereof, or any combination thereof. In a specific embodiment, the tannic acid can comprise a solution, a suspension, an emulsion, a sol, a gel, a solid, a powder, a composite material, or combinations thereof. In a particular embodiment, the tannic acid can be in combination with a polymer, a polymer composite, or combinations thereof. In a particular embodiment, the second antimicrobial agent can comprise bronopol, tannic acid, chitosan, mixtures thereof, blends thereof, or any combination thereof. In a particular embodiment, the second antimicrobial agent can consist essentially of bronopol, tannic acid, chitosan, mixtures thereof, blends thereof, or any combination thereof. As used herein, the phrase “consist essentially of,” “consisting essentially of,” “consists essentially of,” or any such an equivalent phrase, limits the scope of the antimicrobial agent to the specified antimicrobial agent, but the scope can include other materials that do not materially affect the characteristic of being an antimicrobial agent as defined herein.

In other words, an abrasive article according to an embodiment that consists essentially of bronopol, tannic acid, chitosan, mixtures thereof, blends thereof, or any combination thereof does not include another antimicrobial agent.

The second antimicrobial agent can have persistent residual antimicrobial effectiveness against one or more microbial organisms as defined above with respect to the first antimicrobial agent.

The second antimicrobial agent can have persistent residual antimicrobial effectiveness against S. aureus, and one or more of K. pneumoniae, and E. coli as defined above with respect to the first antimicrobial agent.

The second antimicrobial formulation can include a second antimicrobial agent in a particular concentration. In an embodiment, the second antimicrobial formulation can include a second antimicrobial agent at a concentration of at least 0.1 wt % of the total weight of the antimicrobial formulation, such as at a concentration of at least 0.2 wt %, at least 0.3 wt %, at least 0.4 wt %, at least 0.5 wt %, at least 0.6 wt %, at least 0.7 wt %, at least 0.8 wt %, at least 0.9 wt %, at least 1.0 wt %, at least 1.1. wt %, at least 1.2 wt %, at least 1.3 wt %, at least 1.4 wt %, or at least 1.5 wt %. In a non-limiting embodiment, the second antimicrobial formulation can include an antimicrobial agent at a concentration of not greater than 5.0 wt % of the total weight of the antimicrobial formulation, such as at a concentration of not greater than not greater than 4.5 wt %, not greater than 4.0 wt %, not greater than 3.5 wt %, not greater than 3.0 wt %, not greater than 2.5 wt %, not greater than 2.0 wt %, or not greater than 1.5 wt %. It will be appreciated that the second antimicrobial formulation can include an antimicrobial agent at a concentration within any range of maximum or minimum values noted above, such as within a range of from 0.1 wt % to 5.0 wt %, or within a range of from 0.5 wt % to 1.5 wt % of the total weight of the second antimicrobial formulation.

In an embodiment, the second antimicrobial formulation comprises the second antimicrobial agent and abrasive particles uniformly dispersed in a second polymer composition.

In an embodiment, the second antimicrobial formulation can include a second polymer composition (total of all polymeric resins) at a concentration of at least 10 wt % of the total weight of the second antimicrobial formulation, such as at a concentration of at least 15 wt %, at least 20 wt %, at least 21 wt %, at least 22 wt %, at least 24 wt %, at least 26 wt %, at least 28 wt %, or at least 30 wt %. In a non-limiting embodiment, the second antimicrobial formulation can include a second polymer composition at a concentration of not greater than 60 wt %, such as not greater than 55 wt %, not greater than 50 wt %, not greater than 45 wt %, not greater than 40 wt %, not greater than 35 wt %, or not greater than 30 wt %. It will be appreciated that the second antimicrobial formulation can include a second polymer composition at a concentration within any range of maximum or minimum values noted above, such as within a range of 10 wt % to 60 wt %, 20 wt % to 60 wt %, 20 wt % to 50 wt %, or 30 wt % to 50 wt %, or 30 wt % to 40 wt % of the total weight of the second antimicrobial formulation.

In an embodiment, the second polymer composition can comprise phenolic resin. The phenolic resin can be the same as or different from the phenolic resin of the first antimicrobial formulation. In a particular embodiment, the phenolic resin is a phenol formaldehyde resin, more particularly the phenolic resin can comprise a resole resin. The resole resin can be the same as or different from the resole resin of the first antimicrobial formulation. In a particular embodiment, the resole resin is the same as in the first antimicrobial formulation.

In an embodiment, the second antimicrobial formulation can include a resole resin in a particular concentration. In an embodiment, the second antimicrobial formulation can include a resole resin at a concentration of at least 10 wt % of the total weight of the antimicrobial formulation, such as at a concentration of at least 15 wt %, at least 20 wt %, at least 21 wt %, at least 22 wt %, at least 23 wt %, at least 24 wt %, or at least 26 wt %. In a non-limiting embodiment, the second antimicrobial formulation can include a resole resin at a concentration of not greater than 50 wt %, not greater than 40 wt %, not greater than 35 wt % or not greater than 30 wt %. It will be appreciated that the second antimicrobial formulation can include a resole resin at a concentration within any range of maximum or minimum values noted above, such as within a range of 20 wt % to 40 wt %, 20 wt % to 30 wt %, or 25 wt % to 35 wt % of the total weight of the second antimicrobial formulation.

A plurality of abrasive particles, such as described above with respect to the first antimicrobial formulation, can be included in the second antimicrobial formulation. The abrasive particles can be the same as or different from the abrasive particles included in the first antimicrobial formulation. In an embodiment, the second antimicrobial formulation can include silica, emery, garnet, aluminum oxide, silicon carbide, or combinations thereof. The abrasive particles can be of any desired size or shape. In an embodiment, the second antimicrobial formulation can include garnet particles having a mesh of at least #120, or at least #220, at least #240. In an embodiment, garnet particles can include a mesh of not greater than #400. It will be appreciated that garnet particles can have a mesh size within any minimum or maximum range indicated above. In a particular embodiment, the second antimicrobial formulation abrasive particles can consists essentially of #240 aluminum oxide.

In an embodiment, the second antimicrobial formulation can include abrasive particles in a particular concentration. In an embodiment, the second antimicrobial formulation can include abrasive particles at a concentration of at least 20.0 wt % of the total weight of the second antimicrobial formulation, such as at a concentration of at least at least 30 wt %, at least 35 wt %, at least 40 wt %, at least 50 wt %. In a non-limiting embodiment, the second antimicrobial formulation can include abrasive particles at a concentration of not greater than 70 wt %, not greater than 60 wt %, not greater than 50.0 wt %, not greater than 45.0 wt %, or not greater than 40 wt %. It will be appreciated that the second antimicrobial formulation can include abrasive particles at a concentration within any range of maximum or minimum values noted above. In a particular embodiment, the second antimicrobial formulation can include abrasive particles at a concentration within a range of 20.0 wt % to 70.0 wt %, 40.0 wt % to 60.0 wt %, of the total weight of the second antimicrobial formulation.

In an embodiment the second antimicrobial formulation can include any of the one or more fillers, water, or other additives, such as rheology modifiers, defoamers, or pigments as described above with respect to the first antimicrobial formulation.

In an embodiment, the second antimicrobial formulation can include a filler, such as calcium carbonate. In an embodiment, the second antimicrobial formulation can include a filler in a particular concentration. In an embodiment, the second antimicrobial formulation can include a filler at a concentration of at least 5.0 wt % of the total weight of the antimicrobial formulation, such as at a concentration of at least 10.0 wt %. In a non-limiting embodiment, the second antimicrobial formulation can include a filler at a concentration of not greater than 30 wt %, not greater than 25 wt %, not greater than 20 wt %, or not greater than 15.0 wt % of the total weight of the second antimicrobial formulation. It will be appreciated that the second antimicrobial formulation can include a filler at a concentration within any range of maximum or minimum values noted above, such as within a range of 5 wt % to 25 wt %, 10 wt % to 15 wt % of the total weight of the second antimicrobial formulation.

In an embodiment, the second antimicrobial formulation, prior to curing, can include water in a particular concentration. In an embodiment, the second antimicrobial formulation can include water at a concentration of at least 2.0 wt % of the total weight of the antimicrobial formulation, such as at a concentration of at least 4.0 wt %, at least 8.0 wt %, at least 10.0 wt %, at least 12 wt %, or at least 13 wt %. In a non-limiting embodiment, the second antimicrobial formulation can include water at a concentration of not greater than 25 wt %, not greater than 20.0 wt %, or not greater than 15.0 wt %. It will be appreciated that the second antimicrobial formulation can include an antimicrobial agent at a concentration within any range of maximum or minimum values noted above, such as within a range of 10.0 wt % to 20.0 wt %.

As will be appreciated, water can be added to the second antimicrobial formulation to adjust for viscosity or for varying concentrations of materials of the second antimicrobial formulation such as, for example, changes in the concentration of the antimicrobial agent.

In an embodiment, the second antimicrobial formulation can include a wetting agent. In an embodiment, the second antimicrobial formulation can include a wetting agent in a particular concentration. In an embodiment, the second antimicrobial formulation can include a wetting agent in a concentration of at least 0.05 wt % of the total weight of the antimicrobial formulation. In a non-limiting embodiment, the second antimicrobial formulation can include a wetting agent in a concentration of not greater than 3.0 wt %, such as not greater than 2.0 wt %, or not greater than 1.5 wt % of the total weight of the second antimicrobial formulation. In will be appreciated that the second antimicrobial formulation can include a wetting agent at a concentration within any range of maximum or minimum values noted above, such as with a range of 0.05 wt % to 3.0 wt % of the total weight of the second antimicrobial formulation.

In an embodiment, the second antimicrobial formulation can include a defoamer in a particular concentration. In an embodiment, the second antimicrobial formulation can include a defoamer in a concentration of at least 0.1 wt % of the total weight of the antimicrobial formulation, such as at a concentration of at least 0.2 wt %. In a non-limiting embodiment, the second antimicrobial formulation can include a defoamer at a concentration of not greater than 3.0 wt %, such as not greater than 1.5 wt %, not greater than about 1.0 wt %, or not greater than 0.5 wt %. In will be appreciated that the second antimicrobial formulation can include a defoamer at a concentration within any range of maximum or minimum values noted above, such as with a range of 0.1 wt % to 3.0 wt % of the total weight of the second antimicrobial formulation.

In an embodiment, the second antimicrobial formulation can include a pigment. In a particular embodiment, the pigment can include a green pigment. In an embodiment, the second antimicrobial formulation can include a pigment in a particular concentration. In an embodiment, the second antimicrobial formulation can include a pigment in a concentration of at least 0.1 wt % of the total weight of the antimicrobial formulation, such as at least 0.3 wt %. In a non-limiting embodiment, the second antimicrobial formulation can include a wetting agent in a concentration of not greater than 3.0 wt5, such as not greater than 2.0 wt %, not greater than 1.0 wt %, or not greater than 0.7 wt % of the total weight of the second antimicrobial formulation. In will be appreciated that the second antimicrobial formulation can include a pigment in a concentration within any range of maximum or minimum values noted above, such as with a range of 0.1 wt % to 1.0 wt % of the total weight of the second antimicrobial formulation.

### Nonwoven Substrate Material

Referring back to FIG. 4, step 402 includes impregnating a nonwoven substrate material with the first antimicrobial formulation. A suitable nonwoven substrate material, such as for a scrubber pad, can be formed to have a particular shape. In an embodiment, the nonwoven substrate material can be in the form of a roll or a sheet, and can be cut to be a regular shape, such as round, oval, square, or can be cut to be an irregular shape, or combinations thereof. In a particular embodiment, the nonwoven substrate material can have a square shape, and more particularly a rectangular shape. In a particular embodiment, the nonwoven substrate material can be formed into a substrate for a scrubber pad, such as a kitchen scrubber pad.

The nonwoven substrate material can comprise a synthetic material, a natural material, or combinations thereof. The material can be an absorbent material, a nonabsorbent material, or combinations thereof. In an embodiment, the nonwoven material can include different variety of aliphatic and aromatic polyamide i.e., nylons and different variety of aliphatic and aromatic polyesters, or a combination thereof.

The nonwoven substrate can be of any desired weight. In a particular embodiment, the weight of the nonwoven substrate material per unit area can be in a range of about 100 GSM to 500 GSM, such as 150 GSM to 200 GSM, or about 160 GSM to about 180 GSM (i.e., grams per square meter, or g/m2).

The nonwoven substrate material can have any desired suitable loft. In a specific embodiment the loft is 12-14 mm and a weight per unit area within a range of 230-250 GSM. In accordance with an embodiment, the nonwoven substrate material can include one or more binders to adhere and interlock the threads (fibers) of the nonwoven web. In a particular embodiment, the binder can include natural or synthetic rubber latex, a large range of acrylic binder, melamine formaldehyde resin, or a combination thereof. In an embodiment, the composition of the binder formulation comprises acrylic latex and melamine formaldehyde resin. The composition of such binder is given in Table A. The nonwoven substrate material is cured at 120° C.-170° C. prior to application of the first antimicrobial formulation or the second antimicrobial formulation.

TABLE A
Binder Formulation

| Material | Amount (wt %) |
|---|---|
| Acrylic Latex | 45 |
| Melamine Formaldehyde Resin | 3 |
| Catalyst 700 | 0.2 |
| Wetting Agent | 0.1 |
| Defoaming Agent | 0.1 |
| Green Pigment | 0.5 |
| Water | 51.1 |

In an embodiment, the nonwoven substrate material can have a particular thickness. Thickness can be defined as the minimum exterior dimension of the nonwoven substrate material. In an embodiment, the nonwoven substrate material can have a thickness that is at least 1 mm, such as at least 5 mm, at least 10 mm, at least 15 mm, at least 20 mm, or even at least 25 mm. In a non-limiting embodiment, the nonwoven substrate material can have a thickness that is not greater than 100 mm, such as not greater than 50 mm, or even not greater than 30 mm. It will be appreciated that the nonwoven substrate material can have a thickness that is within a range of any minimum or maximum value noted above.

In an embodiment, the nonwoven substrate material can have a particular loft. In an embodiment, the nonwoven substrate material can have a loft of at least 5 mm, such as at least 8 mm, or at least 10 mm. In a non-limiting embodiment, the nonwoven substrate material can have a loft that is not greater than 35 mm, such as not greater than 30 mm, not greater than 20 mm, not greater than 15 mm, or even not greater than 12 mm. It will be appreciated that the nonwoven substrate material can have a loft that is within a range of any maximum or minimum value noted above, such as within a range of 8 mm to 14 mm.

In an embodiment, the nonwoven substrate material can have a particular weight per unit area, defined as grams per square meter, or GSM. In an embodiment, the nonwoven substrate material can have a weight of at least 200 GSM, such as at least 220 GSM, or at least 240 GSM. In a non-limiting embodiment, the nonwoven substrate material can have a weight per unit area of not greater than 300 GSM, such as not greater than 270 GSM, or even not greater than 250 GSM. It will be appreciated that the nonwoven substrate material can have a weight per unit area within a range of any minimum or maximum value noted above, such as within a range of 240 GSM to 250 GSM.

### Fragrance

The antimicrobial nonwoven abrasive article can further comprise a fragrance. In an embodiment, the fragrance can comprise at least one perfume, eau de toilette, toilet water, eau de cologne, or cologne. In an embodiment, the perfume can be a citrus compound, a non-citrus compound, or a combination thereof. The fragrance can be present in a solvent.

The fragrance may be present in a particular concentration. In an embodiment, the fragrance can be at a concentration of at least 0.01 wt % of the total weight of the antimicrobial nonwoven abrasive, such as at a concentration of at least 0.2 wt %, or at least 0.3 wt %. In a non-limiting embodiment, the fragrance can include an antimicrobial agent at a concentration of not greater than 1 wt % of the total weight of the antimicrobial formulation, such as at a concentration of not greater than not greater than 0.9 wt %, not greater than 0.8 wt %, not greater than 0.7 wt %, not greater than 0.6 wt %, or not greater than 0.5 wt %. It will be appreciated that the antimicrobial nonwoven abrasive can include a fragrance at a concentration within any range of maximum or minimum values noted above, such as within a range of from 0.01 wt % to 1.0 wt %, or within a range of from 0.01 wt % to 0.5 wt % of the total weight of the antimicrobial nonwoven abrasive article.

### Method of Making

Referring back to FIG. 4, step 401 includes preparing the first antimicrobial formulation. The ingredients of the first antimicrobial formulation, as described above can, can be mixed together by any suitable means (e.g., high-shear or low shear mixer) to prepare the first antimicrobial formulation.

Step 402 includes impregnating the nonwoven substrate material with the first antimicrobial formulation. The impregnation can be accomplished by any suitable means or manner that applies a sufficient amount of the first antimicrobial formulation so that the nonwoven substrate material becomes thoroughly soaked with the first antimicrobial formulation. In an embodiment, the impregnation can be accomplished by dipping, spraying, submerging, coating, or washing the nonwoven substrate material with or in the first antimicrobial formulation, or combinations thereof. The impregnation can occur as a single step or multiple steps, such as multiple dipping steps or multiple spraying steps of the nonwoven substrate material, or combinations thereof. In a specific embodiment, the nonwoven fabric is dipped into the first antimicrobial formulation. In another embodiment, the nonwoven substrate material is sprayed with the first antimicrobial formulation.

Optionally, (not shown) the amount of antimicrobial formulation the substrate material is impregnated with can be adjusted. Adjusting the saturation of the first antimicrobial formulation can be accomplished by any method or mechanism that does not overly degrade the nonwoven substrate material, such as pressing, squeezing, brushing, squeegeeing, blowing, dabbing, blotting, rollering, shaking, or combinations thereof, and the like. In a specific embodiment, the impregnated nonwoven substrate material can be squeezed, such as between a pair of rollers to adjust the saturation of the impregnated nonwoven substrate material. During step 402, in an embodiment, the nonwoven substrate material can be impregnated with a specific amount of uncured first antimicrobial formulation. In an embodiment, the nonwoven substrate can be impregnated with at least 200 GSM, at least 300 GSM, at least 400 GSM, at least 500 GSM, at least 600 GSM, or at least 700 GSM of the first antimicrobial formulation. In a non-limiting embodiment, the nonwoven substrate material is impregnated with not greater than 2000 GSM, not greater than 1500 GSM, not greater than 1000 GSM, not greater than 800 GSM, not greater than 700 GSM, or not greater than 600 GSM of the first antimicrobial formulation. It will be appreciated that the nonwoven substrate material can be impregnated with a weight of the first antimicrobial formulation within any range of minimum or maximum values noted above.

In a particular embodiment, the nonwoven substrate material can be impregnated with a weight of the first antimicrobial formulation ranging from 200 GSM to 2000 GSM.

Referring back to FIG. 4, step 403 includes preparing the second antimicrobial formulation. The ingredients of the second antimicrobial formulation, as described above, can be mixed together by any suitable means to form the second antimicrobial formulation.

Post Step 402 operation, Step 404 includes disposing the second antimicrobial formulation on a first side of the nonwoven substrate material. Step 405 includes disposing the second antimicrobial formulation on a second side of the nonwoven substrate material. Steps 404 and 405, similar to step 402, can be accomplished by any suitable method, such as dipping, spraying, submerging, coating, or washing the nonwoven substrate material with or in the first antimicrobial formulation, or combinations thereof. In a specific embodiment, step 404 and step 405 are accomplished by spraying the nonwoven substrate material with the second antimicrobial formulation.

During step 404, in an embodiment, a particular amount of second antimicrobial formulation can be disposed on the first side of the nonwoven substrate material. In a non-limiting embodiment, at least 100 GSM, such as at least 125 GSM, such as at least 150 GSM, such as at least 175 GSM, at least 200 GSM, at least 500 GSM, or at least 750 GSM of the second antimicrobial formulation can be disposed on the first side of the nonwoven substrate material. In a non-limiting embodiment, not greater than 1000 GSM, such as not greater than 750 GSM, not greater than 500 GSM, not greater than 350 GSM, not greater than 325 GSM, not greater than 300 GSM, not greater than 275 GSM, not greater than 250 GSM, or not greater than 200 GSM of the second antimicrobial formulation can be disposed on the first side of the nonwoven substrate material. It will be appreciated that the amount of second antimicrobial formulation disposed on the first side of the nonwoven substrate material can be within any range of minimum or maximum values noted above. In a particular embodiment, the amount of second antimicrobial formulation disposed on the first side of the nonwoven substrate material can be range from 100 GSM to 300 GSM.

During step 405, in an embodiment, a particular amount of uncured second antimicrobial formulation can be disposed on the second side of the nonwoven substrate material. In a non-limiting embodiment, at least 100 GSM, such as at least 125 GSM, at least 150 GSM, at least 175 GSM, at least 200 GSM, at least 500 GSM, or at least 750 GSM of the second antimicrobial formulation can be disposed on the second side of the nonwoven substrate material. In a non-limiting embodiment, not greater than 1000 GSM, such as not greater than 750 GSM, not greater than 500 GSM, not greater than 350 GSM not greater than 325 GSM, not greater than 300 GSM, not greater than 275 GSM, not greater than 250 GSM, or not greater than 200 GSM of the second antimicrobial formulation can be disposed on the second side of the nonwoven substrate material. It will be appreciated that the amount of second antimicrobial formulation disposed on the second side of the nonwoven substrate material can be within any range of minimum or maximum values noted above. In a particular embodiment, the amount of second antimicrobial formulation disposed on the second side of the nonwoven substrate material can be range from 100 GSM to 300 GSM.

Step 406 includes curing the nonwoven substrate material. Curing can be performed by any curing process known in the art. In a particular embodiment, curing can include passing the dip-coated and/or spray-coated web though an oven at a temperature that will sufficiently cure the first antimicrobial formulation and/or the second antimicrobial formulation, but that will not destroy the efficacy of the first or second antimicrobial agent(s). In a particular embodiment, the nonwoven substrate material can be cured at an ambient temperature of 120-160° C.

### Abrasive Article

In accordance with an embodiment, the abrasive article provides abrasive performance and persistent residual antimicrobial effectiveness against S. aureus, and one or more of K. pneumoniae, and E. coli as defined above with respect to the first antimicrobial agent.

Surprisingly, the persistent residual antimicrobial effectiveness lasts over an extended period of time and/or extensive usage of the abrasive article. In an embodiment, the abrasive article possesses persistent residual effectiveness even after extensive usage, such as even after cleaning approximately 200 utensils, 600 utensils or even 1000 utensils. In an embodiment, the abrasive article possesses persistent residual effectiveness even after cleaning 600 utensils and being stored wet in a sealed bag for seven days.

In an embodiment, the abrasive article can have a particular weight, defined as grams per square meter, or GSM. In an embodiment, the abrasive article can have a weight of at least at least 300 GSM, at least 500 GSM, at least 750 GSM, at least 850 GSM, or at least 1050 GSM.

In a non-limiting embodiment, the abrasive article can have a weight of not greater than 3000 GSM, such as not greater than 2000 GSM, not greater than 1500 GSM, or not greater than 1300 GSM. It will be appreciated that the abrasive article can have a weight within a range of any minimum or maximum value noted above, such as within a range of 300 GSM to 3000 GSM. In a particular embodiment, the abrasive can have a weight per unit area within a range of 1050 GSM to 1150 GSM.

The completed abrasive article can have a particular measure of nonwoven substrate material compared to the total weight of the abrasive article (which includes the combined amount of cured first antimicrobial formulation and cured second antimicrobial formulation disposed on and in the nonwoven substrate material). In accordance with an embodiment, the abrasive article can have a GSM ratio of the weight of the nonwoven substrate material prior to being impregnated and sprayed with the first ad second antimicrobial formulation (GSM nonwoven) to the weight of the final cured abrasive article (GSM final). In an embodiment, the abrasive article can have a GSM ratio (i.e., GSM nonwoven:GSM final) of at least 1:2, meaning that the weight in GSM of the final cured abrasive article has at least twice a much weight as the nonwoven substrate material from which it was formed. In an embodiment, the GSM ratio can be at least 1:3, at least 1:4, or at least 1:5. In a non-limiting embodiment, the GSM ratio can be not greater than 1:15, such as not greater than 1:6, or not greater than 1:5. It will be appreciated that the GSM ratio can be within a range of any minimum or maximum value noted above. In a particular embodiment, the GSM ratio can be within a range of 1:3 to 1:6, and more particularly within a range of 1:4 to 1:5.

### EMBODIMENTS

### Embodiment 1

An antimicrobial abrasive article comprising: a nonwoven substrate material impregnated with a first formulation; wherein the first formulation comprises a first antimicrobial agent and abrasive particles uniformly dispersed in a first polymer composition, and wherein the first antimicrobial agent comprises bronopol, tannic acid, chitosan, any combination thereof, or a mixture thereof.

### Embodiment 2

The antimicrobial abrasive article of embodiment 1, further comprising; a coating of a second formulation disposed on a first side and on a second side of the nonwoven substrate material, wherein the second formulation comprises a second antimicrobial agent and abrasive particles uniformly dispersed in a second polymer composition.

### Embodiment 3

The antimicrobial abrasive article of embodiment 1, wherein the antimicrobial abrasive article comprises persistent residual antimicrobial effectiveness defined as capable of killing at least about 85%, at least about 90%, or at least about 95% of the population of an initial inoculation of one or more microbial organisms after 1 hour.

### Embodiment 4

The antimicrobial abrasive article of embodiment 3, wherein persistent residual antimicrobial effectiveness is further defined as capable of killing at least about 85%, at least about 90%, or at least about 95% of the population of an initial inoculation of one or more microbial organisms after seven days.

### Embodiment 5

The antimicrobial abrasive article of embodiment 3, wherein the one or more microbial organisms include S. aureus, K. pneumoniae, E. coli, or any combination thereof.

### Embodiment 6

The antimicrobial abrasive article of embodiment 3, wherein the persistent residual antimicrobial effectiveness is defined as capable of killing at least about 85%, such as at least 90%, or at least 95% of the population of an initial inoculation of E. coli after 1 hour; at least 85%, such as at least 90%, or at least 95% of the population of an initial inoculation of K. pneumonia after 1 hour, and killing at least 95% of the population of an initial inoculation of S. aureus after 1 hour.

### Embodiment 7

The antimicrobial abrasive article of embodiment 4, wherein the persistent residual antimicrobial effectiveness is defined as capable of killing at least about 85%, such as at least 90%, or at least 95% of the population of an initial inoculation of E. coli after seven days, at least 85%, such as at least 90%, or at least 95% of the population of an initial inoculation of K. pneumonia after seven days, and killing at least 95% of the population of an initial inoculation of S. aureus after seven days.

### Embodiment 9

The antimicrobial abrasive article of embodiment 2, wherein the antimicrobial abrasive article retains persistent residual antimicrobial effectiveness over cleaning of at least 200 utensils, at least 300 utensils, at least 400 utensils, at least 500 utensils, at least 600 utensils, or at least 1000 utensils.

### Embodiment 10

The antimicrobial abrasive article of embodiment 1, wherein the antimicrobial abrasive article produces minimal malodor.

### Embodiment 11

The antimicrobial abrasive article of embodiment 1, wherein the first antimicrobial formulation comprises: 0.1 wt % to 5.0 wt % of a first antimicrobial agent; 20 wt % to 70 wt % of abrasive particles; and 10 wt % to 60 wt % of a first polymer composition.

### Embodiment 12

The antimicrobial abrasive article of embodiment 1, wherein the first antimicrobial agent comprises bronopol.

### Embodiment 13

The antimicrobial abrasive article of embodiment 1, wherein the first antimicrobial agent comprises tannic acid.

### Embodiment 14

The antimicrobial abrasive article of embodiment 1, wherein the first antimicrobial agent comprises Chitosan.

### Embodiment 15

The antimicrobial abrasive article of embodiment 1, further comprising a filler uniformly dispersed in the first polymer composition.

### Embodiment 16

The antimicrobial abrasive article of embodiment 15, wherein the first formulation comprises: 0.1 wt % to 5.0 wt % first antimicrobial agent; 20 wt % to 70 wt % abrasive particles; 10 wt % to 60 wt % first polymer composition; and 5 wt % to 30 wt % filler.

### Embodiment 17

The antimicrobial abrasive article of embodiment 2, wherein the second formulation comprises: 0.1 wt % to 5.0 wt % second antimicrobial agent; 20 wt % to 70 wt % abrasive particles; and 10 wt % to 60 wt % second polymer composition.

### Embodiment 18

The antimicrobial abrasive article of embodiment 2, wherein the second antimicrobial agent comprises bronopol, tannic acid, chitosan, any combination thereof, or a mixture thereof.

### Embodiment 19

The antimicrobial abrasive article of embodiment 2, further comprising a filler uniformly dispersed in the second formulation.

### Embodiment 20

The antimicrobial abrasive article of embodiment 19, wherein the second formulation comprises: 0.1 wt % to 5.0 wt % second antimicrobial agent; 20 wt % to 70 wt % abrasive particles; 10 wt % to 60 wt % second polymer composition; and 5 wt % to 30 wt % filler.

### Embodiment 21

The antimicrobial abrasive article of embodiment 1, further comprising a fragrance.

### Embodiment 22

The antimicrobial abrasive article of embodiment 21, wherein the fragrance comprises a perfume, an eau de toilette, a toilet water, an eau de cologne, a cologne, a combination thereof, or a mixture thereof.

### Embodiment 23

The antimicrobial abrasive article of embodiment 22, where the fragrance comprises 0.01 wt. % to 0.5 wt. % perfume.

### Embodiment 24

A method of making an antimicrobial abrasive article comprising: preparing a first formulation; and impregnating a nonwoven substrate material with the first formulation, wherein the first formulation comprises a first antimicrobial agent and abrasive particles uniformly dispersed in a first polymer composition, and wherein the first antimicrobial agent comprises bronopol, tannic acid, chitosan, any combination thereof, or a mixture thereof.

### Embodiment 25

The method of embodiment 24, wherein the antimicrobial abrasive article comprises persistent residual antimicrobial effectiveness defined as capable of killing at least about 85%, at least about 90%, or at least about 95% of the population of an initial inoculation of one or more microbial organisms after 1 hour.

### Embodiment 26

The method of embodiment 24, wherein preparing the first formulation comprises: mixing together the first antimicrobial agent, the first polymer composition, and the abrasive particles, wherein the first antimicrobial agent and the abrasive particles are uniformly dispersed in the first polymer composition.

### Embodiment 27

The method of embodiment 24, wherein preparing the first formulation comprises mixing together ingredients comprising: 0.1 wt % to 5 wt % first antimicrobial agent; 10 wt % to 60 wt % phenol formaldehyde resin; 2 wt % to 20 wt % melamine formaldehyde resin; 5 wt % to 30 wt % filler; 20 wt % to 70 wt % abrasive particles; and 2 wt % to 25 wt % water.

### Embodiment 28

An antimicrobial abrasive article comprising:
a nonwoven substrate material impregnated with a first formulation;
wherein the first formulation comprises a first antimicrobial agent and abrasive particles
uniformly dispersed in a first polymer composition, and
wherein the first antimicrobial agent comprises bronopol, tannic acid, chitosan, any combination thereof, or a mixture thereof.

### Embodiment 29

The antimicrobial abrasive article of embodiment 28, further comprising;
a coating of a second formulation disposed on a first side and on a second side of the nonwoven substrate material,
wherein the second formulation comprises a second antimicrobial agent and abrasive particles uniformly dispersed in a second polymer composition.

### Embodiment 30

The antimicrobial abrasive article of embodiment 28, wherein the antimicrobial abrasive article comprises persistent residual antimicrobial effectiveness defined as capable of killing at least about 85% of the population of an initial inoculation of one or more microbial organisms after 1 hour.

### Embodiment 31

The antimicrobial abrasive article of embodiment 30, wherein persistent residual antimicrobial effectiveness is further defined as capable of killing at least about 85% of the population of an initial inoculation of one or more microbial organisms after seven days.

### Embodiment 32

The antimicrobial abrasive article of embodiment 30, wherein the one or more microbial organisms include S. aureus, K. pneumoniae, E. coli, or any combination thereof.

### Embodiment 33

The antimicrobial abrasive article of embodiment 30, wherein the persistent residual antimicrobial effectiveness is defined as capable of killing at least about 85% of the population of an initial inoculation of E. coli after 1 hour; at least 85% of the population of an initial inoculation of K. pneumonia after 1 hour, and killing at least 95% of the population of an initial inoculation of S. aureus after 1 hour.

### Embodiment 34

The antimicrobial abrasive article of embodiment 31, wherein the persistent residual antimicrobial effectiveness is defined as capable of killing at least about 85% of the population of an initial inoculation of E. coli after seven days, at least 85% of the population of an initial inoculation of K. pneumonia after seven days, and killing at least 95% of the population of an initial inoculation of S. aureus after seven days.

### Embodiment 35

The antimicrobial abrasive article of embodiment 28, wherein the first antimicrobial formulation comprises:
0.1 wt % to 5.0 wt % of a first antimicrobial agent;
20 wt % to 70 wt % of abrasive particles; and
10 wt % to 60 wt % of a first polymer composition.

### Embodiment 36

The antimicrobial abrasive article of embodiment 28, wherein the first antimicrobial agent comprises bronopol, tannic acid, chitosan, any combination thereof, or a mixture thereof.

### Embodiment 37

The antimicrobial abrasive article of embodiment 28, further comprising a filler uniformly dispersed in the first polymer composition, wherein the first formulation comprises:
0.1 wt % to 5.0 wt % first antimicrobial agent;
20 wt % to 70 wt % abrasive particles;
10 wt % to 60 wt % first polymer composition; and
5 wt % to 30 wt % filler.

### Embodiment 38

The antimicrobial abrasive article of embodiment 29, wherein the second formulation comprises:
0.1 wt % to 5.0 wt % second antimicrobial agent;
20 wt % to 70 wt % abrasive particles; and
10 wt % to 60 wt % second polymer composition.

### Embodiment 39

The antimicrobial abrasive article of embodiment 29, wherein the second antimicrobial agent comprises bronopol, tannic acid, chitosan, any combination thereof, or a mixture thereof.

### Embodiment 40

The antimicrobial abrasive article of embodiment 29, further comprising a filler uniformly dispersed in the second formulation, wherein the second formulation comprises:
0.1 wt % to 5.0 wt % second antimicrobial agent;
20 wt % to 70 wt % abrasive particles;
10 wt % to 60 wt % second polymer composition; and
5 wt % to 30 wt % filler.

### Embodiment 41

The antimicrobial abrasive article of embodiment 28, further comprising a fragrance.

### Embodiment 42

A method of making an antimicrobial abrasive article comprising:
preparing a first formulation; and
impregnating a nonwoven substrate material with the first formulation, wherein the first formulation comprises a first antimicrobial agent and abrasive particles
uniformly dispersed in a first polymer composition, and wherein the first antimicrobial agent comprises bronopol, tannic acid, chitosan, any combination thereof, or a mixture thereof.

### EXAMPLES

### Example 1—Preparation of an Antimicrobial Abrasive Article (“Scrubber Pad”)

A nonwoven material (“substrate” or “backing”) as described herein was dip coated with a first antimicrobial formulation and then spray coated with a second antimicrobial formulation to form a scrub pad having a persistent residual antimicrobial efficacy. A first antimicrobial formulation (also called herein a dip coating formulation) was prepared by mixing together the components listed below in Table B. Polymeric resins, abrasive grain, anti-foaming agent, wetting agent, calcium carbonate filler, pigment, and water were mixed together to form a precursor composition. The first antimicrobial agent was mixed into the precursor composition to form the first antimicrobial formulation having a concentration of 1.5 wt % of first antimicrobial agent. The nonwoven material was dip coated in the antimicrobial composition using a two-roll coater.

A second antimicrobial formulation (also called herein a spray coating formulation) was formed similarly as the first antimicrobial formulation. The composition of the spray coating formulation is listed below in Table C. The dip and spray-coated web was cured in an oven at about 120-160° C. to form a cured completed antimicrobial abrasive article.

TABLE B
The composition of Dip Coating formulation

| Materials | Amount (wt.%) |
|---|---|
| Phenol formaldehyde Resin | 26.9 |
| MF Resin (Melamine | 8.2 |
| formaldehyde) | |
| SAPCO NXZ (Anti foaming | 0.2 |
| agent) | |
| Aquafil OT (wetting agent) | 0.1 |
| Antimicrobial agent | 1.5 |
| CFL DURA (Calcium | 11.5 |
| carbonate) | |
| #220 Garnet | 37.6 |
| Green Pigment | 0.50 |
| Water | 13.5 |

TABLE C
The composition of Spray Coating formulation

| Materials | Amount (wt. %) |
|---|---|
| EHR Resin | 23.0 |
| SAPCO NXZ | 0.2 |
| Aquafil OT | 0.1 |
| Antimicrobial agent | 1.5 |
| CFL DURA | 10.0 |
| #240 DCF (Aluminum | 50.0 |
| Oxide) | |
| Green Pigment | 0.50 |
| Water | 14.7 |

The following inventive antimicrobial scrub pads were produced: Inventive 1 (3.0 wt % Chitosan); Inventive 2 (1.5 wt % Bronopol).

Control and Comparative samples were also prepared by following the same procedure and materials as above except that the control sample did not contain any antimicrobial agent and the comparative samples included 1.5 wt % of a comparative antimicrobial agent in the antimicrobial dip coating and antimicrobial spray coating. The following control and comparative antimicrobial scrub pads were produced: Control 1 (no antimicrobial agent); Comparative 1 (1.5 wt % Zyocil); Comparative 2 (1.5 wt % Didecyldimethylammonium Chloride) and Comparative 3 (1.5 wt % Zinc Pyrithione).

### A. Zone of Inhibition Testing (Virgin Samples)

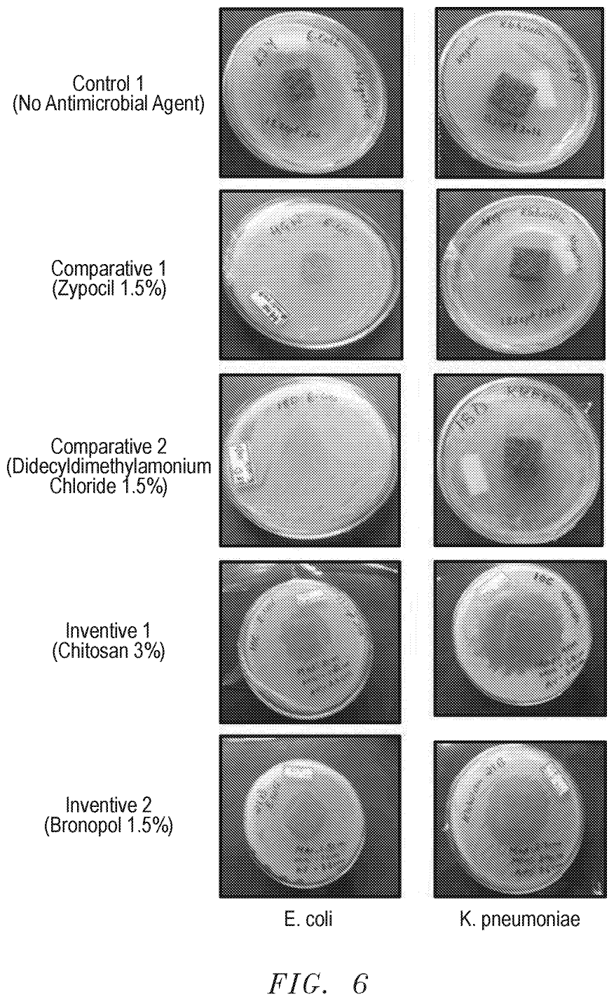

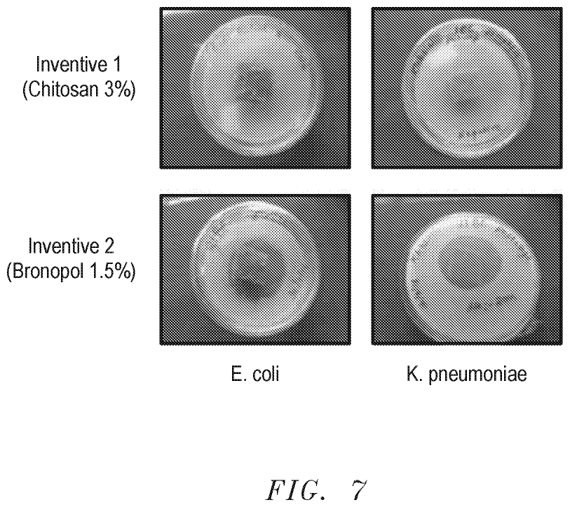

The control sample, inventive samples, and comparative samples were evaluated for persistent residual antimicrobial activity with respect to organisms E. coli and K. pneumonia according to the well known Kirby-Bauer antibiotic testing method. All samples were cut to the same size (approximately 1 cm₂) and each sample was placed in separate petri dishes upon a substrate inoculated with a particular microbial organism. In particular, the samples used were virgin samples (i.e., new samples not yet subjected to washing utensils or other cleaning procedures). After 24 hours, the samples were observed to determine if any existing zone of inhibition was present. The results are shown in FIG. 6. As is shown, the control sample (Control 1) and the comparative samples (Comparative 1 and Comparative 2) did not produce a discernable zone of inhibition. In contrast, both inventive samples (Inventive 1 and Inventive 2) did produce acceptable zones of inhibition surrounding the samples.

### B. Zone of Inhibition Testing (Used Samples—200 Utensils)

Inventive samples (Inventive 1 and Inventive 2) were again evaluated for persistent residual antimicrobial activity with respect to organisms E. coli and K. pneumonia; however, prior to testing, each inventive sample was used to wash numerous utensils (200 utensils). The used inventive samples were then cut to the same size (approximately 1 cm2), placed in inoculated petri dishes, and subjected to Kirby-Bauer antibiotic testing method as described above. The results are shown in FIG. 7. As is shown, Inventive 1 (3.0 wt % Chitosan) unexpectedly did not produce an acceptable zone of inhibition. In contrast, Inventive 2 (1.5 wt % Bronopol) did produce an acceptable zone of inhibition.

### C. Antimicrobial Activity—ASTM: E2149-13A—Virgin Samples

Additional inventive scrub pads (1.5 wt % Bronopol pad and 1.5 wt % tannic acid pad) were produced as described above. Antimicrobial testing of the inventive samples was conducted according to ASTM: E2149-13A. In particular, the tested samples were virgin samples (i.e., new samples not yet subjected to washing utensils or other cleaning procedures); used samples (used to wash 200 kitchen utensils); and further used pads (used to cleaning 600 kitchen utensils and kept under wet condition for 7 days before testing). The % reduction of bacteria results are provided below in Table D.

TABLE D
Antimicrobial Efficacy

| | % Reduction in microbial activity | | | | | | | | |
|---|---|---|---|---|---|---|---|---|---|
| | | | | | | | Used pads | | |
| | | | | | | | (Cleaned 600 kitchen utensils, | | |
| | | | | Used pads | | | stored under wet condition for | | |
| Antimicobial | Fresh Pads | | | (Cleaned 200 kitchen utensils) | | | 7 days and then tested for activity) | | |
| Agents | E. Coli | K. pneumonia | S. aureus | E. Coli | K. pneumonia | S. aureus | E. Coli | K. pneumonia | S. aureus |
| 1.5% Bronopol | 99.9 | 98.8 | 99.0 | 97.7 | 95.3 | 93.9 | 99.4 | 98.8 | 98.9 |
| 1.5% Tannic Acid | 98.3 | 98.0 | 98.8 | 97.7 | 94.7 | 94.4 | 99.9 | 98.5 | 99.3 |

The test results indicate that the inventive samples had persistent residual antimicrobial effectiveness against S. aureus, E. coli, and K. pneumonia after washing 200 utensils as well as even after extended usage (600 utensils) and extended storage (seven days) under wet conditions.

Note that not all of the activities described above in the general description or the examples are required, that a portion of a specific activity can not be required, and that one or more further activities can be performed in addition to those described. Still further, the order in which activities are listed are not necessarily the order in which they are performed.

### D. Odor Analysis

Additional comparative (1.5 wt % Zinc Pyrithione) and inventive (1.5 wt % and 2.5 wt % Tannic Acid) scrub pads were produced as described above. The odor concentration of a gaseous sample of odorants is determined according to European standard method EN13725. The odor sources were contaminated water and vegetable cottage cheese based gravy. The contaminated water or vegetable cottage cheese based gravy were applied on the antibacterial scrub pad. The samples were stored for 48 hours to develop malodor in an air tight bag. After 24 hr, air was analyzed for odor concentration by using four trained odor assessors according to EN 13725 standard. The test results of inventive scrub pads were calculated by considering the malodor of comparative scrub pad as 100%. The inventive scrub pads exhibit lower malodor than the comparative scrub pad (Table E).

TABLE E
Malodor reduction analysis

| | | | Vegetable - Cottage cheese | |
|---|---|---|---|---|
| | Contaminated water | | based gravy | |
| | | % Malodor | | % Malodor |
| Sample | % Malodor | Reduction | % Malodor | Reduction |
| Comparative | 100.00 | — | 100.00 | — |
| Scrub Pad | | | | |
| (1.5% Zinc | | | | |
| Pyrithione) | | | | |
| Inventive Scrub | 52.97 | 47.03 | 42.04 | 57.96 |
| Pad (1.5% | | | | |
| Tannic Acid) | | | | |
| Inventive Scrub | 28.06 | 71.94 | 32.42 | 67.58 |
| Pad (2.5% | | | | |
| Tannic Acid) | | | | |

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but can include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, can also be provided in combination in a single embodiment. Conversely, various features that are, for brevity, described in the context of a single embodiment, can also be provided separately or in any subcombination.

Further, references to values stated in ranges include each and every value within that range. When the terms “about” or “approximately” precede a numerical value, such as when describing a numerical range, it is intended that the exact numerical value is also included. For example, a numerical range beginning at “about 25” is intended to also include a range that begins at exactly 25.

1. An antimicrobial abrasive article comprising:
a nonwoven substrate material impregnated with a first formulation;
wherein the first formulation comprises a first antimicrobial agent and abrasive particles uniformly dispersed in a first polymer composition; and
wherein the first antimicrobial agent comprises bronopol, tannic acid, chitosan, any combination thereof, or a mixture thereof.

2. The antimicrobial abrasive article of claim 1, further comprising;
a coating of a second formulation disposed on a first side and on a second side of the nonwoven substrate material, wherein the second formulation comprises a second antimicrobial agent and abrasive particles uniformly dispersed in a second polymer composition.

3. The antimicrobial abrasive article of claim 1, wherein the antimicrobial abrasive article comprises persistent residual antimicrobial effectiveness defined as capable of killing at least about 85% of the population of an initial inoculation of one or more microbial organisms after 1 hour.

4. The antimicrobial abrasive article of claim 3, wherein persistent residual antimicrobial effectiveness is further defined as capable of killing at least about 85% of the population of an initial inoculation of one or more microbial organisms after seven days.

5. The antimicrobial abrasive article of claim 3, wherein the one or more microbial organisms include S. aureus, K. pneumoniae, E. coli, or any combination thereof.

6. The antimicrobial abrasive article of claim 3, wherein the persistent residual antimicrobial effectiveness is defined as capable of killing at least about 85% of the population of an initial inoculation of E. coli after 1 hour; at least 85% of the population of an initial inoculation of K. pneumonia after 1 hour, and killing at least 95% of the population of an initial inoculation of S. aureus after 1 hour.

7. The antimicrobial abrasive article of claim 4, wherein the persistent residual antimicrobial effectiveness is defined as capable of killing at least about 85% of the population of an initial inoculation of E. coli after seven days, at least 85% of the population of an initial inoculation of K. pneumonia after seven days, and killing at least 95% of the population of an initial inoculation of S. aureus after seven days.

8. The antimicrobial abrasive article of claim 1, wherein the first antimicrobial formulation comprises:
0.1 wt. % to 5.0 wt. % of a first antimicrobial agent;
20 wt. % to 70 wt. % of abrasive particles; and
10 wt. % to 60 wt. % of a first polymer composition.

9. The antimicrobial abrasive article of claim 1, wherein the first antimicrobial agent comprises bronopol, tannic acid, chitosan, any combination thereof, or a mixture thereof.

10. The antimicrobial abrasive article of claim 1, further comprising a filler uniformly dispersed in the first polymer composition, wherein the first formulation comprises:
0.1 wt. % to 5.0 wt. % first antimicrobial agent;
20 wt. % to 70 wt. % abrasive particles;
10 wt. % to 60 wt. % first polymer composition; and
5 wt. % to 30 wt. % filler.

11. The antimicrobial abrasive article of claim 2, wherein the second formulation comprises:
0.1 wt. % to 5.0 wt. % second antimicrobial agent;
20 wt. % to 70 wt. % abrasive particles; and
10 wt. % to 60 wt. % second polymer composition.

12. The antimicrobial abrasive article of claim 2, wherein the second antimicrobial agent comprises bronopol, tannic acid, chitosan, any combination thereof, or a mixture thereof.

13. The antimicrobial abrasive article of claim 2, further comprising a filler uniformly dispersed in the second formulation, wherein the second formulation comprises:
0.1 wt. % to 5.0 wt. % second antimicrobial agent;
20 wt. % to 70 wt. % abrasive particles;
10 wt. % to 60 wt. % second polymer composition; and
5 wt. % to 30 wt. % filler.

14. The antimicrobial abrasive article of claim 1, further comprising a fragrance.

15. The antimicrobial abrasive article of claim 14, wherein the fragrance comprises a perfume, an eau de toilette, a toilet water, an eau de cologne, a cologne, a combination thereof, or a mixture thereof.

16. The antimicrobial abrasive article of claim 15, where the fragrance comprises 0.01 wt. % to 0.5 wt. % perfume.

17. A method of making an antimicrobial abrasive article comprising:
preparing a first formulation; and
impregnating a nonwoven substrate material with the first formulation;
wherein the first formulation comprises a first antimicrobial agent and abrasive particles uniformly dispersed in a first polymer composition; and
wherein the first antimicrobial agent comprises bronopol, tannic acid, chitosan, any combination thereof, or a mixture thereof.

18. The method of claim 17, wherein the antimicrobial abrasive article comprises persistent residual antimicrobial effectiveness defined as capable of killing at least about 85% of the population of an initial inoculation of one or more microbial organisms after 1 hour.

19. The method of claim 17, wherein preparing the first formulation comprises: mixing together the first antimicrobial agent, the first polymer composition, and the abrasive particles, wherein the first antimicrobial agent and the abrasive particles are uniformly dispersed in the first polymer composition.

20. The method of claim 17, wherein preparing the first formulation comprises mixing together ingredients comprising:
0.1 wt. % to 5 wt. % first antimicrobial agent;
10 wt. % to 60 wt. % phenol formaldehyde resin;
2 wt. % to 20 wt. % melamine formaldehyde resin;
5 wt. % to 30 wt. % filler;
20 wt. % to 70 wt. % abrasive particles; and
2 wt. % to 25 wt. % water.
